(19) United States
(12) Patent Application Publication
(10) Pub. No.: US 2024/0378810 A1
(43) Pub. Date: Nov. 14, 2024

(54) PROVIDING ACCESS TO MESH GEOMETRY FROM IMAGES OF OBJECTS

(71) Applicant: GOOGLE LLC, Mountain View, CA (US)

(72) Inventors: Min Xia, Mountain View, CA (US); John Richard Ullman, Belmont, CA (US); Stevan Lacerda Muniz Silva, San Jose, CA (US); David James Richey, Castro Valley, CA (US); Carlos David Correa Ocampo, Santa Clara, CA (US); Robert Raymond Pasquini, Scotts Valley, CA (US)

(21) Appl. No.: 18/660,176

(22) Filed: May 9, 2024

Related U.S. Application Data
(60) Provisional application No. 63/501,091, filed on May 9, 2023.
(60) Provisional application No. 63/501,093, filed on May 9, 2023.
(60) Provisional application No. 63/501,099, filed on May 9, 2023.
(60) Provisional application No. 63/501,102, filed on May 9, 2023.

(51) Int. Cl. G06T 17/20; G06T 7/73

(52) U.S. Cl. CPC G06T 17/20; G06T 7/74; G06T 2207/30184; G06T 2210/36

(57) ABSTRACT

Techniques include providing a mesh geometry for an image of an object to an application. In this way, an application that provides the image of the object can then overlay the mesh geometry onto the image. For example, when the object is a building, an image of a building is provided by a camera used by an application. The application can be configured to determine the three-dimensional location of the building based on the image provided by the camera. The application can be configured to determine a mesh geometry for the building based on the determined location. The application can be configured to obtain the mesh geometry and overlay the image of the building (virtual building) with the mesh geometry.

### CROSS REFERENCE TO RELATED APPLICATIONS

This application claims the benefit of U.S. Provisional Application No. 63/501,091, filed May 9, 2024, U.S. Provisional Application No. 63/501,093, filed May 9, 2024, U.S. Provisional Application No. 63/501,099, filed May 9, 2024, and U.S. Provisional Application No. 63/501,102, filed May 9, 2024, the disclosures of which are incorporated herein by reference in their entireties.

### BACKGROUND

A developer of map-related applications may generate virtual buildings, e.g., images of buildings, by capturing images of buildings with a camera. In map-related applications, objects such as buildings can be represented by a mesh geometry.

### SUMMARY

The concepts described herein make it possible for a developer to obtain a representation of the three-dimensional object using an image of the object. This in turn makes developing, for example, a map-related or gaming application more efficient and allows the developer to provide a better experience for the end user of the application. Specifically, the concepts discussed herein are directed to determining a mesh geometry for an object such as a building based on an image of the object. For example, an application may receive an image of the object from a camera. The application can determine a location of the object based on the image. For example, the application can be configured to use a visual positioning system (VPS) to determine the location of the object from the image, and then may determine a mesh geometry for the object based on the location of the object. For example, the determination of the mesh geometry may be accomplished by performing a lookup of the location within a set of cells, which are indexed to locations on the Earth. When the lookup is done using a service, the set of cells can contain a mesh geometry for objects. Thus, the mesh geometry for an object may be made available from one or more cells containing the mesh geometry for the object. The processing circuitry then may provide the mesh geometry for the object to the application. The application may then overlay the mesh geometry with the image of the object.

In one general aspect, a method can include receiving, from a camera associated with an application, an image of an object. The method can also include determining, based on the image of the object, a location of the object. The method can further include determining, based on the location of the object, a mesh geometry representation of the object. The method can further include providing the mesh geometry representation of the object to the application.

In another general aspect, a computer program product comprising a non-transitory storage medium, the computer program product including code that, when executed by processing circuitry, causes the processing circuitry to perform a method. The method can include receiving, from a camera associated with an application, an image of an object. The method can also include determining, based on the image of the object, a location of the object. The method can further include determining, based on the location of the object, a mesh geometry representation of the object. The method can further include providing the mesh geometry representation of the object to the application.

In another general aspect, a system comprises memory and processing circuitry coupled to the memory. The processing circuitry can be configured to receive, from a camera associated with an application, an image of an object. The processing circuitry can also be configured to determine, based on the image of the object, a location of the object. The processing circuitry can further be configured to determine, based on the location of the object, a mesh geometry representation of the object. The processing circuitry can further be configured to provide the mesh geometry representation of the object to the application.

The details of one or more implementations are set forth in the accompanying drawings and the description below. Other features will be apparent from the description and drawings, and from the claims.

### BRIEF DESCRIPTION OF THE DRA WINGS

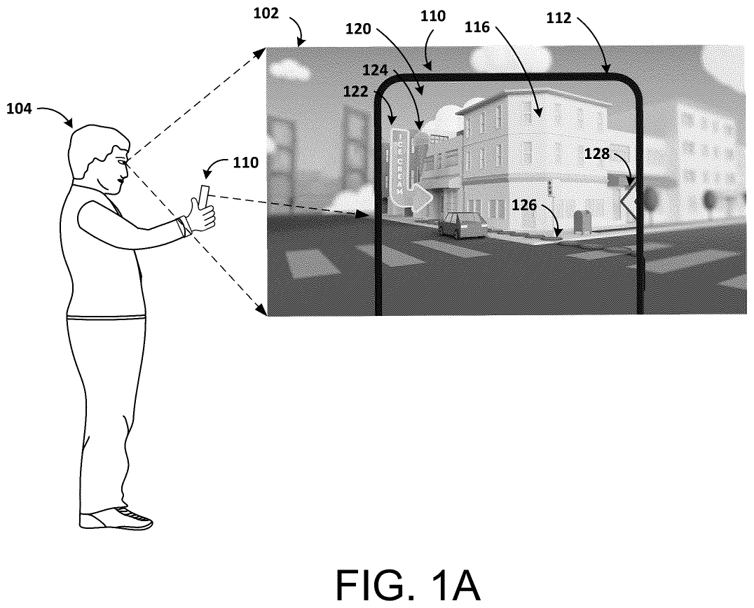

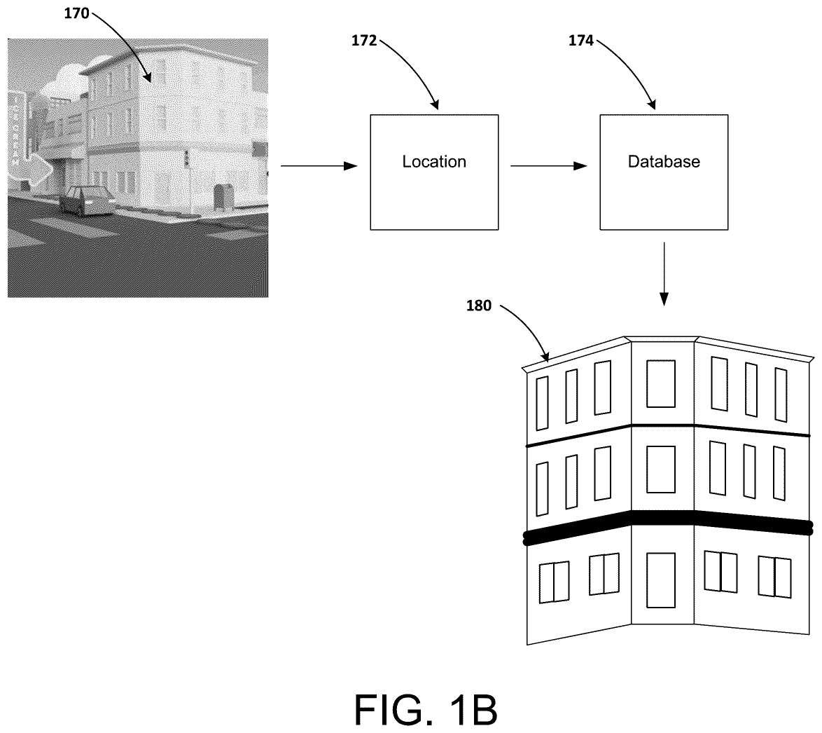

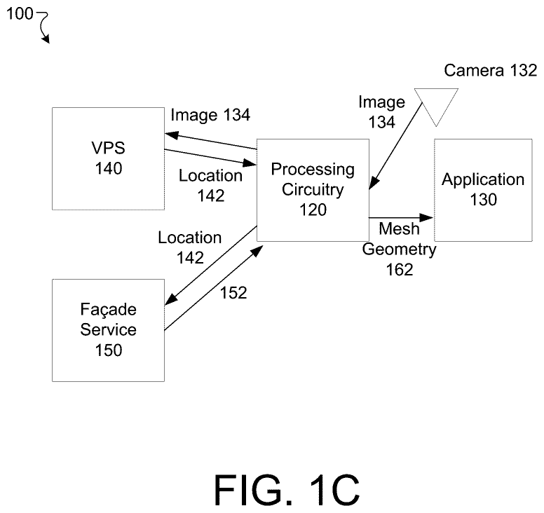

FIG. 1A is a diagram illustrating an example development of a map-related or gaming application using a mobile device.

FIG. 1B is a diagram illustrating an example acquisition of a building representation from an image of an environment containing the building.

FIG. 1C is a diagram illustrating an example flow representing determining a mesh geometry of an object from an image of the object in accordance with implementations described herein.

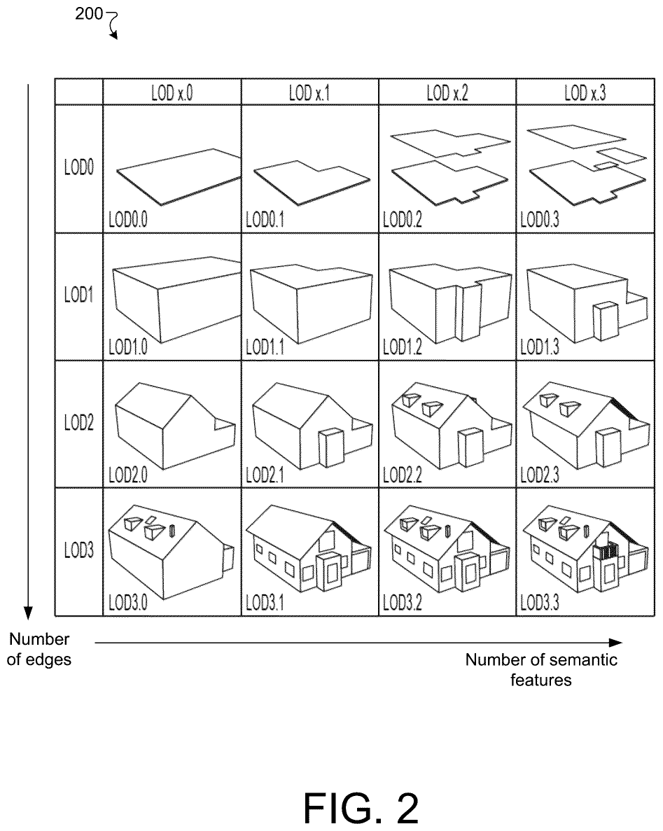

FIG. 2 is a diagram illustrating an example table of levels of detail (LODs) of mesh geometries.

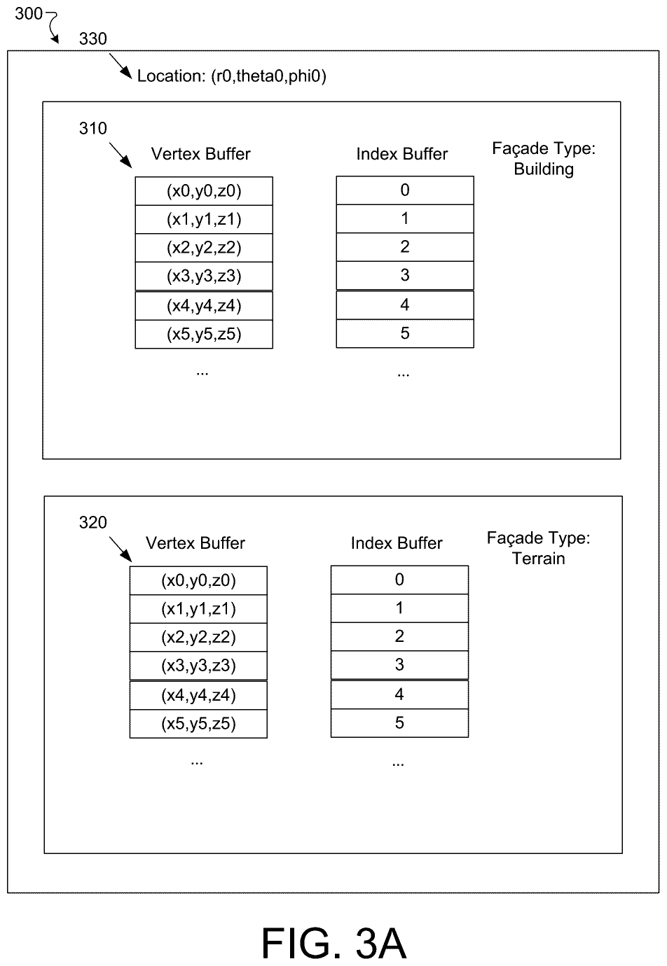

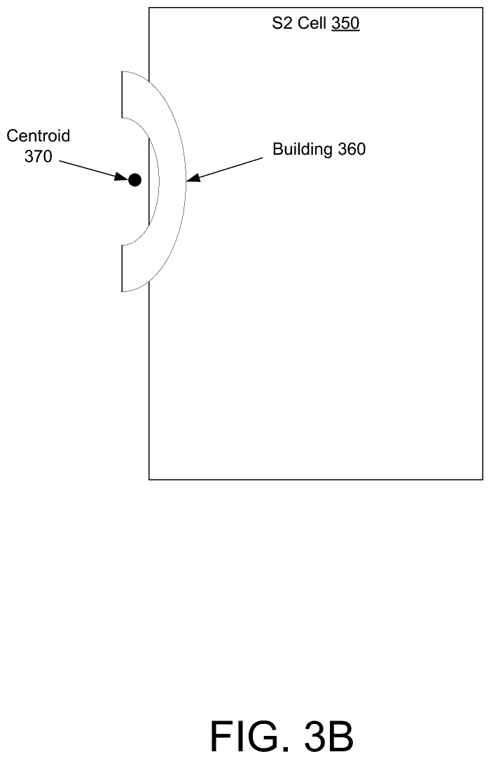

FIG. 3A is a diagram illustrating an example cell with a mesh geometry buffer included.

FIG. 3B is a diagram illustrating an example cell with a mesh geometry extending outside of the cell.

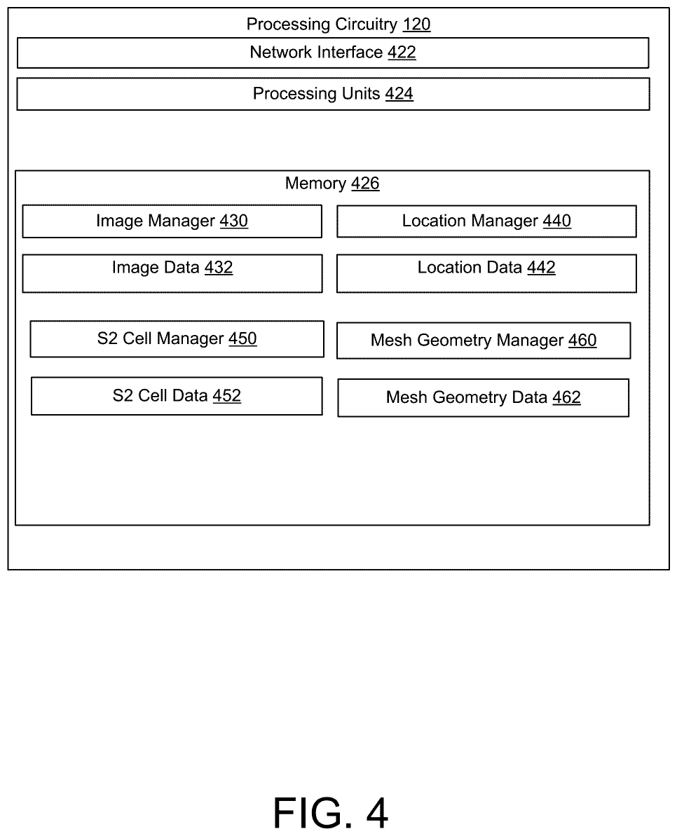

FIG. 4 is a diagram illustrating an example electronic environment in which a mesh geometry for an object is obtained from an image of the object.

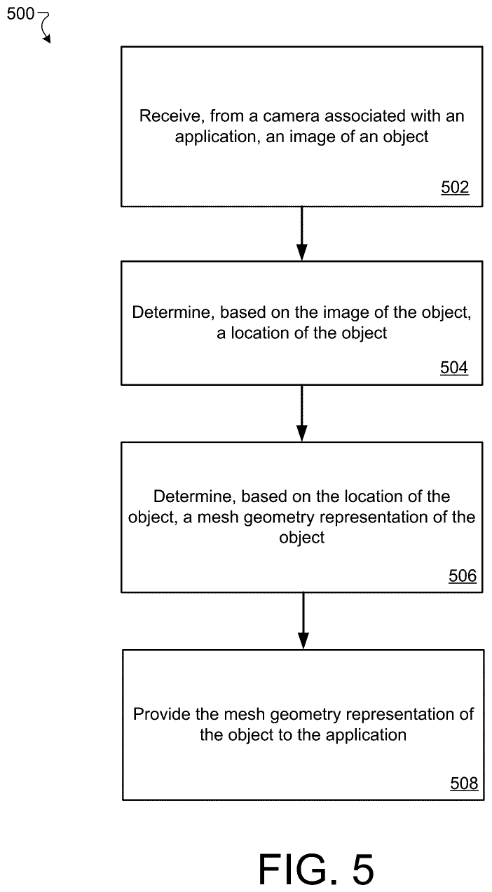

FIG. 5 is a flow chart illustrating an example process of determining mesh geometry from an image of an object.

### DETAILED DESCRIPTION

Developers of map-related applications frequently work with complex three-dimensional objects such as buildings and surrounding terrain and grapple with how such objects are represented in the application being developed. It is difficult for a developer of a map-related or gaming application to represent complex three-dimensional objects in their application because of the mathematical complexity of the representation. Nevertheless, based on the concept described herein, it is possible for a developer to obtain a representation of the three-dimensional object using an image of the object. This in turn makes developing, for example, a map-related or gaming application more efficient and allows the developer to provide a better experience for the end user of the application.

For example, in map-related or gaming applications, buildings (structures, facades) and their surroundings (terrain) can be represented by three-dimensional objects. A user can interact with such an application on a computing device, e.g., on a laptop or desktop computer, on a mobile device such as a mobile phone or a tablet computer, or the user can interact with the application using a computing device such as an augmented reality/mixed reality/virtual reality (AR/MR/VR) device. On a computer, the user can interact with the application using a mouse, a keyboard, a trackpad, or similar input device. On a mobile device, a user can interact with the application by touching the surface of the device and making finger gestures, e.g., pinching to zoom in, moving the finger to scroll location. On a computing device, the user can interact with the application using a hand controller or by making hand gestures in front of a camera on the device.

A user can interact with a map-related or gaming application by virtually traveling to a building site and examining the building and surroundings from any number of different perspectives. For example, on a mobile device, the user can view detail of a building and surroundings from any perspective using, for example, a controller and/or a gesture (e.g., by moving their fingers on a touchscreen of a device). In some applications, a user can enter a door of a building and see a new environment, e.g., a representation of the indoor environment. In some applications, the user can see buildings from an overhead perspective and view rooftops on the buildings.

A challenge for map-related or gaming applications is to represent the buildings in such a way as to represent physical reality on the ground. For example, a first building in front of a second building should block the second building from view when the perspective is on or near the ground. The second building, however, should become more visible from a different perspective, e.g., away from the first building or from a higher elevation. Moreover, objects should not pass through the first building and interact with the second building but, if there is a collision with the first building, interact with the first building.

Such a challenge may be met by a developer of the map-related or gaming application. A developer is a person that creates the map-related or gaming application using an application programming interface (API). A developer of map-related or gaming applications may generate virtual buildings by capturing images of buildings with a camera. In map-related or gaming applications, objects such as buildings can be represented by a mesh geometry. The mesh geometry can include terrain as well as buildings, and the mesh geometry for the terrain may be interleaved with the mesh geometry for the buildings. The mesh geometry can allow for physical interactions and defining occlusions.

At least one technical problem with the map-related or gaming applications is that it is difficult to generate the mesh geometry for a virtual building, e.g., a structure of a building.

At least one technical solution to the technical problem includes providing a mesh geometry for an image of an object to an application. In this way, an application that provides the image of the object can then overlay the mesh geometry onto the image. For example, when the object is a building, an image of a building is provided by a camera used by (associated with) an application. The application can be configured to determine the three-dimensional location of the building based on the image provided by the camera. The application then determines a mesh geometry for the building based on the determined location. The application may then obtain the mesh geometry and overlay the image of the building (virtual building) with the mesh geometry.

It is noted that a mesh geometry representation of an object such as a building is an approximation of the object using a three-dimensional mesh. In other words, the mesh geometry representation can be a representation of an object such as a building is an approximation of the object using a three-dimensional mesh. The three-dimensional mesh can take the form of a set of vertices, or coordinates in three-dimensional space. In some implementations, the mesh can include, or can be made of, triangles. Adjacent vertices of the set of vertices can be arranged pairwise to define a set of edges that may also define the mesh geometry representation of the object. Moreover, the set of edges can be arranged in groups, e.g., triplets, to define a set of faces that may also define the mesh geometry representation of the object. The mesh geometry representation of an object represents the structure of an object.

In some implementations, the application can be configured to determine the location of the building by sending the image of the building to a visual positioning system (VPS). The VPS compares the building in the image to that in a precomputed VPS index which is linked to a known, three-dimensional location. It is noted that VPS is favored for obtaining location data over a global positioning system (GPS). For example, GPS may not be as accurate as VPS, e.g., GPS is accurate out to about 10 m while VPS is accurate out to about 1 m.

In some implementations, the application can be configured to determine the three-dimensional mesh geometry for the building using a façade service. The façade service stores a database of mesh geometries in indexed S2 cells. In some implementations, an S2 cell can be a region of the Earth, bounded by four geodesics and indexed along a space-filling curve. In some implementations, an S2 cell can be a region of the Earth bounded by (e.g., defined by) one or more longitudinal lines and/or latitude lines. In some implementations, an S2 cell can be a region of the Earth indexed along a line or curve. In some implementations an S2 cell can be a region of the Earth indexed along a line or curve that traverses every S2 cell defined within the Earth. The façade service, in response to receiving a three-dimensional location, returns an S2 cell corresponding to that location. The S2 cell contains the three-dimensional mesh geometry for buildings and terrain located within the region of the Earth represented by the S2 cell. In some implementations, a building and a terrain have separate three-dimensional mesh geometries.

In some implementations, a three-dimensional mesh geometry is provided at some level of detail (LOD). In some implementations, the LOD can refer to a number of levels of detail. In some implementations, the LOD can refer to a quantity or a number of 3D sub-objects that are included in another object. In some implementations, the LOD can refer to a quantity or a number of sub-objects that are used to make another object in a 3D environment. The LOD can refer to the number of vertices, edges, or faces in the three-dimensional mesh geometry representation of a building. In some implementations, the LOD has a numerical representation of the form LODx.y or LOD (x,y), where x indicates a number of edges in the mesh geometry representation of the building and y indicates a number of semantic features in the mesh geometry representation of the building. In some implementations, semantic features are identifying features in a building that may be used by people, e.g., doors, windows. In some implementations, semantic features can include decorative and/or utilitarian features or objects associated with an object. In some implementations, semantic features can include features associated with an object that are not part of the structural aspects of an object such as a building. In some implementations, semantic features can include features associated with a façade of an object such as a building. In some implementations, the three-dimensional mesh geometry is provided at an LOD. In some implementations, there is more than one LOD for a three-dimensional mesh geometry. In such implementations, the application may select an LOD. In some implementations, the application may specify that some LODs be excluded from transmission to the application, e.g., if x<X and y<Y.

To access a three-dimensional mesh geometry, an application may copy a buffer storing the three-dimensional mesh geometry. The copy operation, however, is an O(N) operation, where N is the number of vertices, and may therefore be resource-heavy. In some implementations, however, the processing circuitry provides access to pointers to the buffer, which would avoid the copy operation while enabling access to the three-dimensional mesh geometry.

The processing circuitry may upload images from the camera at specific time intervals (e.g., every 5 seconds, every 10 seconds, etc.). This may be a network-resource-heavy feature. In some implementations, however, the processing circuitry may provide a toggle to the application that, when activated, enables the application to turn off the upload feature so that the camera is no longer uploading images to the processing circuitry.

At least one technical benefit of the technical solution lies with the ability to quickly generate mesh geometries for buildings in map-related applications.

FIG. 1A is a diagram illustrating an example development of a map-related or gaming application using a mobile device 110. The development of the map-related or gaming application as shown in FIG. 1A involves capturing an image of an environment 102 that includes a building 116. Based on the concept described herein, it is possible for a developer to obtain a representation of the three-dimensional object using the image of the environment 102. This in turn makes developing, for example, a map-related application, a gaming application, and so forth, more efficient and allows the developer to provide a better experience for the end user of the application.

Users of AR/MR/VR devices can experience AR/MR/VR content while moving around in a location. For example, referring to FIG. 1A, a user of a mobile device 110 (which can be any type of mobile device) executing AR/MR/VR software can view virtual objects on, for example, landmarks in the real-world environment 102 while observing the display 120 of the mobile device 110. For example, a user of mobile device 110 can view objects 122, 124, 126, and 128 while observing the display 120 of the mobile device 110. The AR/MR/VR content is typically generated by a developer 104 using the mobile device 110.

FIG. 1A illustrates the developer 104 using the mobile device 110 to generate content and the image to the right illustrates the environment 102 being viewed by the user while using the mobile device 110 to capture an image of the environment 102 using a camera 112 on the mobile device 110. The camera 112 in this case is world-facing, meaning that it faces away from the developer using the mobile device 110. The mobile device 110 captures the image while running an application, e.g., an application programming interface (API). An API provides the developer 104 tools used to interact with the, e.g., map-related or gaming application under development.

FIG. 1B is a diagram illustrating an example acquisition of a building representation from an image 170 of an environment (e.g., environment 102 of FIG. 1A) containing the building.

The developer uses the image 170 of the environment 102 to determine a location 172 of a building 116 in the environment 102. In some situations, the developer could bypass the image and use a global positioning system (GPS) to determine a location. The GPS location, however, may not be accurate enough to determine a location of a building precisely, as the accuracy of GPS is about 10 meters. Using an image, however, can produce a more accurate location, e.g., about 1 meter, which is accurate enough to locate the building 116. The location 172 may be determined by comparing the objects 122, 124, 126, and 128 (FIG. 1A) with those in an image database that also includes location.

Once the location 172 of the building 116 has been determined, the AR/MR/VR content is determined based on the location 172 of the building 116. The AR/MR/VR content takes the form of a representation of the building 116 in an immersive environment. In some cases, representation of the building 116 may have a high fidelity to the building 116, meaning that the representation of the building 116 looks much like the building 116, down to the windows and door. In some cases, the representation of the building 116 may have a low fidelity to the building 116, meaning that the representation of the building 116 does not look much like the building 116.

The representation 180 of the building 116 is stored in a database 174, sorted by location on the Earth. By using the location 172 determined from the image of the environment 102, the representation of the building 116 may be found in the database 174. In some implementations, the location 172 in the database 174 is contained within a section of the Earth that is approximately rectangular, bounded by latitude and longitude lines. In that case, a lookup operation includes determining which section of the Earth contains the location 172 determined from the image of the environment 102.

Once the developer of the map-related or gaming application receives the representation 180 of the building 116, the developer can then use the representation 180 of the building 116 is the application being developed. For example, the developer can use the API to overlay the representation 180 of the building 116 onto the image of the building 116. This would allow for, e.g., consideration of collisions with objects on the building 116.

The representation 180 has a fair degree of fidelity with the building 116. For example, the representation 180 shows the general shape of the building 116, as well as windows and the door. However, the representation 180 is lacking in many details such as shading.

A user can interact with the representation 180 of the building 116. For example, the user could have an avatar enter the representation 180 of the building 116 through the door, which would cause a new environment to be displayed to the user, representing an interior of the building 116.

FIG. 1C is a diagram illustrating an example flow 100 representing determining a mesh geometry of an object from an image of the object. The flow 100 is not limiting and there may be other flow topologies that may accomplish a similar result.

As shown in FIG. 1C, a camera 132 associated with an application 130 sends an image 134 of, e.g., a building to processing circuitry 120. In some implementations, the camera 132 is a camera of a mobile device on which the application is being developed. In some implementations, the camera 132 is a camera of an augmented reality/extended reality device on which the application runs.

On processing circuitry 120, an application development support system runs that provides data and code that, when executed, causes the application 130 to perform map-related operations. For example, the application development support system includes an ARCore software development kit (SDK) that provides code for augmented reality-related applications.

The image 134 includes an image of an object, e.g., a building. In some implementations, the image 134 includes images of other objects such as landmarks (e.g., signs) that may be used to identify the object.

The processing circuitry 120, in response to receiving the image 134, determines a location 142 of the object in the image 234. In some implementations and as shown in FIG. 1B, the processing circuitry 120 determines the location 142 by sending the image to a visual positioning system (VPS).

A VPS is a positioning system that uses computer vision and machine learning algorithms to determine a location of a device in the physical world. In this case, the device is the camera 132. In some implementations, the location 142 is a three-dimensional location. In some implementations, when the object is a building, the three-dimensional location corresponds to a rooftop of the building.

The processing circuitry 120 then uses the location 142 to determine a mesh geometry for the object. In some implementations, and as shown in FIG. 1C, the processing circuitry 120 performs a lookup operation of an S2 cell 152 in a façade service 150. An S2 cell is a section of the Earth, bounded by four geodesics, and indexed along a space-filling curve superimposed on the Earth. That is, an S2 cell 152 corresponds to a location on Earth and may be searched in a directory by location. Moreover, the façade service 150 provides a mesh geometry 162 for an object at the location 142 in an S2 cell 152. In this way, an S2 cell is a data structure representing a section of the Earth including the location of the object, the data structure including the mesh geometry representation of the object.

In some implementations, the mesh geometry is provided at a level of detail (LOD). An LOD represents a measure of fidelity a mesh geometry has to the object it represents. In some implementations, the LOD is provided by the façade service 150 for a particular object. In some implementations, there is more than one LOD for a given object.

The processing circuitry 120 then provides the mesh geometry 162 to the application 130. For example, the application 130 can access the mesh geometry by copying the buffer in the S2 cell where the vertex information defining the mesh geometry is stored. For meshes of high LODs, however, this can be a costly operation in terms of resources. A solution to this problem is described with regard to FIG. 3A.

FIG. 2 is a diagram illustrating an example table 200 of levels of detail (LODs) of mesh geometries. As shown in FIG. 2, the LOD is described using a first number and a second number. For example, for the first number, LOD0 represents a footprint, LOD1, represents a three-dimensional box over that footprint, and LOD2 and LOD3 represent additional features (e.g., roofs, dormers) that describe the building shape. In this case, the first number for the LOD, e.g., LODx, is indicative of a number of edges in the mesh geometry representation of a building. In some implementations, LODx is indicative of a number of vertices in the mesh geometry representation of the building. In some implementations, LODx is indicative of a number of faces in the mesh geometry representation of the building.

In a mesh geometry representation of an object, there is a set of vertices, which are coordinates in three-dimensional space. The vertices provide an approximation of the object's shape. The mesh geometry representation of the object also has a set of edges, which are formed by pairwise joining of adjacent vertices of the set of vertices. The number of edges is, in some implementations, equal to the number of unique adjacent pairs of vertices of the set of vertices. In some implementations, the set of edges can be arranged in groups, e.g., triplets, to define a set of faces of the mesh geometry representation of the object. The number of faces is, in some implementations, equal to a number of unique groupings of adjacent edges, e.g., a number of triplets of adjacent edges for triangular faces.

In some implementations, for an LODx, there is a second number LODx.y that represents details on the features. For example, LOD2.0 represents a house with a slanted roof, while LOD2.1 has a chimney, and LOD2.2 has dormers on the roof. Moreover, LOD3.1, LOD3.2, and LOD3.3 have semantic features such as windows and doors.

Semantic features are features that provide additional detail to an object but are not represented using additional vertices, edges, or faces of a three-dimensional mesh. For example, semantic features are those features of a building that make the building appear occupied by people, e.g., windows, doors, dormers, chimneys.

In some implementations, the application 130 (FIG. 1B) may choose to not access mesh geometries that have particular LODs. In some implementations, the application 130 chooses those LODs that are greater than a threshold, e.g., LODx.y, where x>X and y>Y. For example, X=0 and Y=1. In some implementations, the application 130 chooses those LODs that are smaller than a threshold, e.g., LODx.y, where x<X and y<Y.

In some implementations, there is one mesh geometry in a given S2 cell, and that mesh geometry has an LOD that is not specified by the application 130. In some implementations, however, there is more than one mesh geometry in an S2 cell for a given object, and those mesh geometries are at different LODs. In that case, the application 130 can select which LOD to access.

FIG. 3A is a diagram illustrating an example S2 cell 300 with mesh geometry buffer included as obtained from the façade service 150 (FIG. 1C). Structure (e.g., building) and terrain (streetscape) geometry are grouped by S2 cells. S2 cells are hierarchically arranged divisions of the Earth into sections of a sphere that approximates the Earth's shape. An S2 cell is a quadrilateral bounded by four geodesics. Cell levels range from 0 to 30. The smallest cells at the lowest level of hierarchy are called leaf cells and there are 6*4\hat{ }30 leaf cells, a leaf cell about 1 cm across on the surface of the Earth.

In some implementations, the S2 cell also includes the location 330 of the building for which a lookup operation in the façade service (e.g., façade service 150, FIG. 1C) that produced the S2 cell 300 occurred. For example, as shown in FIG. 3A, the location of the building is given by (r0, theta0, phi0), e.g., three-dimensional spherical coordinates, where theta0 represents a latitude, phi represents a longitude, and r0 represents an elevation, e.g., above sea level. The S2 cell 300 includes this location 330 as well as others within the four geodesics that bound the quadrilateral defining the S2 cell 300.

An S2 cell may contain a terrain and/or a structure; this may be represented as a mesh geometry. A terrain is equivalent to the ground if there is no building there. Conventionally, terrain and building mesh geometries in one S2 cell are grouped in one mesh geometry. A mesh geometry in the streetscape geometry includes a type (e.g., building, terrain) for a face in the meshes. This is an inefficient representation because developers might loop through a buffer to get a terrain mesh if they want only the terrain mesh. Thus, implementations split the streetscape geometry structures in one S2 cell by terrain 320 and buildings 310, as shown in FIG. 3A.

Moreover, when computing rooftop elevation for a particular location, a goal is to have an ability to efficiently and reliably access the mesh geometry which might be considered part of the rooftop surface at that location. This rooftop surface, e.g., the top of a building at a given horizontal location or terrain if there is no building at the given location, includes both the global streetscape geometry terrain and building mesh geometry which covers the location. Nevertheless, it is difficult to reliably or efficiently find the global streetscape structure geometry which might cover a given location. For example, global streetscape structure geometry is approximately spatially indexed.

A tile is aligned at a 1:1 scale with S2 cells. In some implementations, tiles are partitioned by level 15 S2 cells (e.g., between 281 m and 306 m wide). A tile contains the terrain mesh geometry which covers that S2 cell and a mesh geometry for any building whose centroid is within that S2 cell's boundaries. Significantly, the mesh geometry of a building contained within one tile might extend outside of the boundaries of the tile's associated S2 cell, into regions that may be represented by other tiles.

FIG. 3B is a diagram illustrating an example S2 cell 350 with a building 360 extending outside of the S2 cell. For example, in FIG. 3B, while most of the building 360 is in S2 cell 350, the centroid 370 is in a neighbor S2 cell. Thus, to find the building mesh geometry which covers a particular region, one cannot only look at the tile corresponding to the S2 cell which contains that location. Some mesh geometry covering that location might be included in other nearby tiles. It is difficult to determine which tiles might need to be inspected to find the mesh geometry which might cover a given location.

Implementations involve splitting the mesh geometry in one S2 cell into one terrain and multiple buildings geometry, as shown in FIG. 3A. Such implementations also involve splitting building mesh geometry along tile boundaries and, within a tile, storing the mesh geometries which fall within the tile's associated S2 cell, including partial meshes for structures which straddle multiple cells, and none of the structure geometry which falls outside of the S2 cell.

As stated previously, applications can obtain the vertices and indices buffers in buildings and terrain (streetscape) mesh geometry, which can perform a copy of a mesh geometry buffer in an access. Copying a mesh geometry buffer at every access is inefficient because copying uses a loop over the buffer and is an O(N) operation in time, where N is the number of vertices in the mesh geometry buffer.

Implementations include a mesh geometry application programming interface (API) providing pointers to buffers in which the mesh geometry representation of a building, e.g., where vertex and index buffers of the streetscape geometry mesh, are stored. For example, a pointer is an address in memory, and a buffer is a location in memory where vertices and indices are stored. In some implementations, a pointer to a buffer can be, or can include an address where the vertices and indices of a mesh geometry representation of an object (e.g., a building) are stored.

Providing the pointers to the buffers can avoid copying at an access. Since little prevents applications from editing any other memory block, e.g., applications can typecast a geometry pointer to a character pointer. In this case, by casting the geometry pointer to a character pointer, an application can cause a computer to reinterpret the bits in the geometry session as characters. Because both geometry pointers and character pointers would point to the same location in memory, the content stored in that location may be overridden. Accordingly, this recasting of the geometry pointers can be a good choice if it is assumed the application is not malicious.

Moreover, the geometry session pointer is a shared pointer, which means the pointer will be valid as long as the developer still refers to it. That is, a shared pointer is used when one heap-allocates a resource that is shared among multiple objects. The shared pointer maintains a reference count internally and deletes the resource when the reference count goes to zero. In this way, a developer API can access mesh geometry data even though a mesh geometry session destroyed it. In some implementations, mesh geometries are retrieved from about a 100 m radius of a current position and the buffers in mesh geometries update once when parsing a response from the server. The mesh geometry is static. Pose in mesh geometry is updated with location changes. In this case, if pointers to buffers are provided, there is no concern about overwriting the memory that the application is trying to read.

In some implementations, building and terrain (streetscape) geometry are downloaded at the beginning of a session. Based on observed data, the 95th percentile of network data size per session is about 11 MB and the 95th percentile of mesh geometry response data size is about 3.5 MB. This means mesh geometry increases about 32% data per augmented reality (AR) session. Moreover, for a one-minute session, a visual positioning system (VPS) will use about 1-3 MB while mesh geometries in one location will use about 0.5 MB, e.g., a 20-50% increase in data usage if mesh geometries are enabled. This is a waste of network and local storage if the application 130 does not use a Streetscape Geometry application programming interface (API).

Implementations are directed to adding a StreetscapeGeometryMode as an AR session configuration. An AR session manages the AR system state and handles the session lifecycle. This class is the main entry point into the Streetscape Geometry API. This class enables the application to create a session, configure the session, start or stop the session, and receive frames that allow access to a camera image and device pose. If an application accesses a streetscape geometry, the application may configure the AR session with the StreetscapeGeometryMode. Applications may then be able activate a toggle that stops a receiving of images (frames). An application can begin receiving images at any time if the application uses the Streetscape Geometry API.

In some implementations, a toggle can be a selection or a switch that turns a feature on or off. In this case, when the toggle is activated, the feature—a receiving of images at particular time intervals (e.g., every 10 seconds)—is turned off. The toggle is part of the StreetscapeGeometryMode and allows a developer to turn off a network-heavy feature.

FIG. 4 is a diagram that illustrates processing circuitry 120 (FIG. 1B) configured to determine mesh geometry corresponding to an image of an object.

The processing circuitry 120 includes a network interface 422, one or more processing units 424, and non-transitory memory 426. The network interface 422 includes, for example, Ethernet adaptors, Bluetooth adaptors, and the like, for converting electronic and/or optical signals received from the network to electronic form for use by the processing circuitry 120. The set of processing units 424 include one or more processing chips and/or assemblies. The memory 426 is a storage medium and includes both volatile memory (e.g., RAM) and non-volatile memory, such as one or more read only memories (ROMs), disk drives, solid state drives, and the like. The set of processing units 424 and the memory 426 together form part of the processing circuitry 120, which is configured to perform various methods and functions as described herein as a computer program product.

In some implementations, one or more of the components of the processing circuitry 120 can be, or can include processors (e.g., processing units 424) configured to process instructions stored in the memory 426. Examples of such instructions as depicted in FIG. 4 include an image manager 430, a location manager 440, a S2 cell manager 450, and a mesh geometry manager 460. Further, as illustrated in FIG. 4, the memory 426 is configured to store various data, which is described with respect to the respective managers that use such data.

The image manager 430 is configured to cause the processing circuitry 120 to receive image data 432 representing an image of an object (e.g., a structure such as a building or a streetscape, e.g., a terrain). In some implementations, the image manager 430 receives the image data 432 over a network (e.g., over network interface 422) from a camera (e.g., camera 132, FIG. 1C) associated with an application (e.g., application 130).

The location manager 440 is configured to cause the processing circuitry 120 to determine, as location data 442, a location of the object based on the image data 432. In some implementations, the location manager 440 uses a visual positioning system (VPS) to determine a location of the object. In some implementations, the location data 442 represents a three-dimensional location.

In some implementations, the location of the camera 132 (FIG. 1C) and hence the object is acquired using a global positioning system (GPS). Nevertheless, a VPS is favored over a GPS because in many cases, the VPS tends to be more accurate than the GPS. For example, the GPS tends to have an inaccurate orientation so that the VPS is more accurate especially when considering pose information.

The S2 cell manager 450 is configured to cause the processing circuitry 120 to determine, as S2 cell data 452, an S2 cell that includes the mesh geometry for the object based on the location data 442. The S2 cell data 452 is obtained based on the location data 442, as the S2 cells are indexed by location.

In some implementations, the mesh geometry in an S2 cell is split between a building and a terrain. Such implementations also involve splitting building mesh geometry along tile boundaries and, within a tile, storing the mesh geometries which fall within the tile's associated S2 cell, including partial meshes for structures which straddle multiple cells, and none of the structure geometry which falls outside of the S2 cell.

The mesh geometry manager 460 is configured to cause the processing circuitry 120 to provide an application (e.g., application 130) access to the mesh geometry (mesh geometry data 462) of the S2 cell. For example, in some implementations, the mesh geometry manager 460 provides pointers to the vertex buffer in which the vertices of the mesh geometry is stored. This avoids copying the vertex buffer, which is an O(N) operation where N is the number of vertices in the buffer.

The mesh geometry for a building may be offered at various LODs representing levels of fidelity to the image of the building. For example, LOD values may be expressed as a first number and a second number, where the first number indicates a number of vertices, edges, or faces in the mesh geometry, and the second number indicates a number of semantic features (e.g., doors, windows) in the mesh geometry. As shown in FIG. 2, the LOD for a mesh geometry may be expressed as LODx.y, where x is the first number and y is the second number. In some implementations, a mesh geometry is accessed by an application if the LOD satisfies a condition. For example, the application may only access a mesh geometry if the LOD is greater than a threshold. That is, the mesh geometry has LODx.y, where x>X and y>Y.

The components (e.g., modules, processing units 424) of processing circuitry 120 can be configured to operate based on one or more platforms (e.g., one or more similar or different platforms) that can include one or more types of hardware, software, firmware, operating systems, runtime libraries, and/or so forth. In some implementations, the components of the processing circuitry 120 can be configured to operate within a cluster of devices (e.g., a server farm). In such an implementation, the functionality and processing of the components of the processing circuitry 120 can be distributed to several devices of the cluster of devices.

The components of the processing circuitry 120 can be, or can include, any type of hardware and/or software configured to process attributes. In some implementations, one or more portions of the components shown in the components of the processing circuitry 120 in FIG. 4 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processing circuitry 120 can be, or can include, a software module configured for execution by at least one processor (not shown). In some implementations, the functionality of the components can be included in different modules and/or different components than those shown in FIG. 4, including combining functionality illustrated as two components into a single component.

Although not shown, in some implementations, the components of the processing circuitry 120 (or portions thereof) can be configured to operate within, for example, a data center (e.g., a cloud computing environment), a computer system, one or more server/host devices, and/or so forth. In some implementations, the components of the processing circuitry 120 (or portions thereof) can be configured to operate within a network. Thus, the components of the processing circuitry 120 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the search system can be, or can include, processors configured to process instructions stored in a memory. For example, image manager 430 (and/or a portion thereof), location manager 440 (and/or a portion thereof), S2 cell manager 450 (and/or a portion thereof), and mesh geometry manager 460 (and/or a portion thereof) are examples of such instructions.

In some implementations, the memory 426 can be any type of memory such as a random-access memory, a disk drive memory, flash memory, and/or so forth. In some implementations, the memory 426 can be implemented as more than one memory component (e.g., more than one RAM component or disk drive memory) associated with the components of the processing circuitry 120. In some implementations, the memory 426 can be a database memory. In some implementations, the memory 426 can be, or can include, a non-local memory. For example, the memory 426 can be, or can include, a memory shared by multiple devices (not shown). In some implementations, the memory 426 can be associated with a server device (not shown) within a network and configured to serve the components of the processing circuitry 120. As illustrated in FIG. 4, the memory 426 is configured to store various data, including image data 432 and location data 442.

FIG. 5 is a flow chart illustrating a method 500 of determining a mesh geometry for an object from an image of the object. The method 500 may be performed with processing circuitry, e.g., processing circuitry 120 as shown in FIGS. 1C and 4.

At 502, an image manager (e.g., image manager 430) receives, from a camera (e.g., camera 132) associated with an application (e.g., application 130), an image of an object. For example, a camera on a mobile device or an augmented reality/extended reality device sends an image of a structure (e.g., a building and/or terrain) to the processing circuitry 120.

At 504, a location manager (e.g., location manager 440) determines, based on the image of the object, a location of the object. In some implementations, the location manager queries a visual positioning system (VPS) to determine the location of the object. The VPS may be superior to a global positioning system (GPS) because the GPS has less accuracy than the VPS.

At 506, an S2 cell manager (e.g., S2 cell manager 450) determines, based on the location of the object, a mesh geometry representation of the object. An S2 cell is a small section of the Earth and indexed by location along a space-filling curve. Given the location from the location manager, the S2 cell manager queries a façade service (e.g., façade service 150, FIG. 1) for an S2 cell corresponding to the location. Moreover, the S2 cell obtained from the façade service includes a mesh geometry representation of the object at the location, e.g., a mesh geometry of a building at the location.

At 508, a mesh geometry manager (e.g., mesh geometry manager 560) provides the mesh geometry representation of the object to the application. In some implementations, the mesh geometry manager provides pointers to the buffers in which the vertices defining the mesh geometry are stored.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A method, comprising:
receiving, from a camera associated with an application, an image of an object;
determining, based on the image of the object, a location of the object;
determining, based on the location of the object, a mesh geometry representation of the object; and
providing the mesh geometry representation of the object to the application.

2. The method as in claim 1, wherein the mesh geometry representation of the object has a level of detail (LOD) indicative of a number of edges of the mesh geometry representation of the object.

3. The method as in claim 2, wherein the LOD is specified by the application.

4. The method as in claim 2, wherein the LOD is represented by a first number and a second number, where the first number indicates a number of edges of the object and the second number indicates a number of semantic features of the object.

5. The method as in claim 1, wherein determining the mesh geometry representation of the object includes:
sending the location of the object to a service; and
receiving, from the service, a data structure representing a section of the Earth including the location of the object, the data structure including the mesh geometry representation of the object.

6. The method as in claim 5, wherein the object includes a building and terrain.

7. The method as in claim 6, wherein the mesh geometry representation of the building is separate from the mesh geometry representation of the terrain.

8. The method as in claim 1, wherein determining the location of the object includes:
sending the image of the object to a visual positioning system (VPS); and
receiving the location of the object from the VPS.

9. The method of claim 1, wherein providing the mesh geometry representation of the object to the application includes:
providing a pointer to a buffer in which the mesh geometry representation of the object is stored to the application.

10. The method as in claim 1, further comprising:
providing a toggle that, when activated, stops a receiving of images of objects from the camera associated with the application.

11. A computer program product comprising a non-transitory storage medium, the computer program product including code that, when executed by processing circuitry, causes the processing circuitry to perform a method, the method comprising:
receiving, from a camera associated with an application, an image of an object;
determining, based on the image of the object, a location of the object;
determining, based on the location of the object, a mesh geometry representation of the object; and
providing the mesh geometry representation of the object to the application.

12. The computer program product as in claim 11, wherein the mesh geometry representation of the object has a level of detail (LOD) indicative of a number of edges of the mesh geometry representation of the object.

13. The computer program product as in claim 12, wherein the LOD is specified by the application.

14. The computer program product as in claim 12, wherein the LOD is represented by a first number and a second number, where the first number indicates a number of edges of the mesh geometry representation of the object and the second number indicates a number of semantic features of the mesh geometry representation of the object.

15. The computer program product as in claim 11, wherein determining the mesh geometry representation of the object includes:
sending the location of the object to a façade service; and
receiving, from the façade service, a data structure representing a section of the Earth including the location of the object, the data structure including the mesh geometry representation of the object.

16. The computer program product as in claim 15, wherein the object includes a building and terrain.

17. The computer program product as in claim 16, wherein the mesh geometry representation of the building is separate from the mesh geometry representation of the terrain.

18. The computer program product as in claim 11, wherein determining the location of the object includes:
sending the image of the object to a visual positioning system (VPS); and
receiving the location of the object from the VPS.

19. The computer program product of claim 11, wherein providing the mesh geometry representation of the object to the application includes:
providing a pointer to a buffer in which the mesh geometry representation of the object is stored to the application.

20. The computer program product as in claim 11, wherein the method further comprises:
providing a toggle that, when activated, stops a receiving of images of objects from the camera associated with the application.

21. A system, comprising:
memory; and
processing circuitry coupled to the memory, the processing circuitry being configured to:
receive, from a camera associated with an application, an image of an object;
determine, based on the image of the object, a location of the object;
determine, based on the location of the object, a mesh geometry representation of the object; and
provide the mesh geometry representation of the object to the application.

22. The system as in claim 21, wherein the mesh geometry representation of the object has a level of detail (LOD) indicative of a number of edges of the mesh geometry representation of the object.

23. The system as in claim 21, wherein the processing circuitry configured to determine the mesh geometry representation of the object is further configured to:
send the location of the object to a service; and
receive, from the service, a data structure representing a section of the Earth including the location of the object, the data structure including the mesh geometry representation of the object.

24. The system as in claim 21, wherein the processing circuitry configured to determine the location of the object is further configured to:
send the image of the object to a visual positioning system (VPS); and
receive the location of the object from the VPS.

25. The system as in claim 21, wherein the processing circuitry configured to provide the mesh geometry representation of the object to the application is further configured to:
provide a pointer to a buffer in which the mesh geometry representation of the object is stored to the application.
